(19) United States
(12) Patent Application Publication
(10) Pub. No.: US 2025/0294101 A1
(43) Pub. Date: Sep. 18, 2025

(54) IMAGE PROCESSING APPARATUS, IMAGE FORMING APPARATUS, NON-TRANSITORY RECORDING MEDIUM, AND IMAGE CORRECTION METHOD

(71) Applicant: Kazuki ISHIKURA, KANAGAWA (JP)

(72) Inventor: Kazuki ISHIKURA, KANAGAWA (JP)

(21) Appl. No.: 19/023,374

(22) Filed: Jan. 16, 2025

(30) Foreign Application Priority Data
Mar. 15, 2024 (JP) 2024-040924

(51) Int. Cl. H04N 1/00; G06V 30/10; H04N 1/60

(52) U.S. Cl. CPC H04N 1/00331; G06V 30/10; H04N 1/00938; H04N 1/60

(57) ABSTRACT

An image processing apparatus includes an imager and circuitry. The imager captures an image. The circuitry sets Optical Character Recognition (OCR) software information corresponding to OCR software used for subsequent OCR processing, performs image correction set according to the set OCR software information on the image captured by the imager to obtain a corrected image, and outputs the corrected image.

### CROSS-REFERENCE TO RELATED APPLICATION

This patent application is based on and claims priority pursuant to 35 U.S.C. § 119(a) to Japanese Patent Application No. 2024-040924, filed on Mar. 15, 2024, in the Japan Patent Office, the entire disclosure of which is hereby incorporated by reference herein.

### BACKGROUND

### Technical Field

The present disclosure relates to an image processing apparatus, an image forming apparatus, a non-transitory recording medium, and an image correction method.

### Related Art

Optical Character Recognition (OCR) processing techniques have been developed to automatically extract text information from a scanned image.

### SUMMARY

According to an embodiment of the present disclosure, an image processing apparatus includes an imager and circuitry. The imager captures an image. The circuitry sets Optical Character Recognition (OCR) software information corresponding to OCR software used for subsequent OCR processing, performs image correction set according to the set OCR software information on the image captured by the imager to obtain a corrected image, and outputs the corrected image.

According to an embodiment of the present disclosure, an image forming apparatus includes the image processing apparatus described above and an image forming device to form an image based on image data generated by the image processing apparatus.

According to an embodiment of the present disclosure, a non-transitory recording medium stores a plurality of instructions which, when executed by one or more processors, causes the one or more processors to perform an image correction method. The method includes setting OCR software information corresponding to OCR software used for subsequent OCR processing, performing image correction set according to the set OCR software information on an image captured by an imager to obtain a corrected image, and outputting the corrected image.

According to an embodiment of the present disclosure, an image correction method includes setting OCR software information corresponding to OCR software used for subsequent OCR processing, performing image correction set according to the set OCR software information on an image captured by an imager to obtain a corrected image, and outputting the corrected image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of a scanner according to a first embodiment;

FIG. 2 is a diagram illustrating a configuration of a control block of the scanner illustrated in FIG. 1;

FIG. 3 is a schematic diagram illustrating a configuration for executing OCR preprocessing;

FIG. 4 is a flowchart of OCR preprocessing;

FIG. 5 is a diagram illustrating an example of a software selection screen on a control panel;

FIG. 6 is a diagram illustrating an example of a function selection screen on a control panel;

FIG. 7 is a table associating OCR software information, a color removal/seal impression removal function, and image correction with each other;

FIG. 8 is a diagram illustrating an image according to an example of failure in OCR processing;

FIGS. 9A to 9C are diagrams illustrating different results of OCR processing due to different processing methods of OCR software;

FIG. 10A is a diagram illustrating a result of OCR processing;

FIGS. 10B and 10C are diagrams each illustrating a result of OCR processing when a chromatic color is corrected to be lighter in image correction;

FIGS. 11A and 11B are diagrams illustrating differences in character quality and file size due to compression;

FIG. 12 is a table illustrating methods of low-compression image correction;

FIG. 13A is a normal compression table;

FIG. 13B is a low compression table;

FIG. 14 is a schematic diagram illustrating a configuration for executing OCR preprocessing according to a second embodiment;

FIGS. 15A and 15B are diagrams illustrating differences in character quality and file size due to resolution;

FIG. 16 is a schematic diagram illustrating a configuration for executing OCR preprocessing according to a third embodiment;

FIG. 17A is a diagram illustrating a visible image;

FIG. 17B is a diagram illustrating an invisible image;

FIG. 17C is a diagram illustrating the visible image of FIG. 17A corrected with the invisible image of FIG. 17B;

FIG. 18 is a graph illustrating an example of light absorption characteristics of colorants;

FIG. 19 is a schematic diagram illustrating a configuration for executing OCR preprocessing according to a fourth embodiment;

FIG. 20 is a schematic diagram illustrating a configuration for executing OCR preprocessing according to a fifth embodiment;

FIGS. 21A to 21C are diagrams each illustrating automatic association of image correction by artificial intelligence (AI) according to a sixth embodiment; and

FIG. 22 is a schematic diagram illustrating a configuration of an image forming apparatus according to a seventh embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, like reference signs denote like elements such as parts and materials having the same functions, and redundant descriptions thereof are omitted unless otherwise required.

In the following description, suffixes Y, M, C, and K denote colors of yellow, magenta, cyan, and black, respectively. To simplify the description, these suffixes are omitted unless necessary.

Embodiments of an image processing apparatus, an image forming apparatus, a program, and an image correction method will be described in detail below with reference to the accompanying drawings.

### First Embodiment

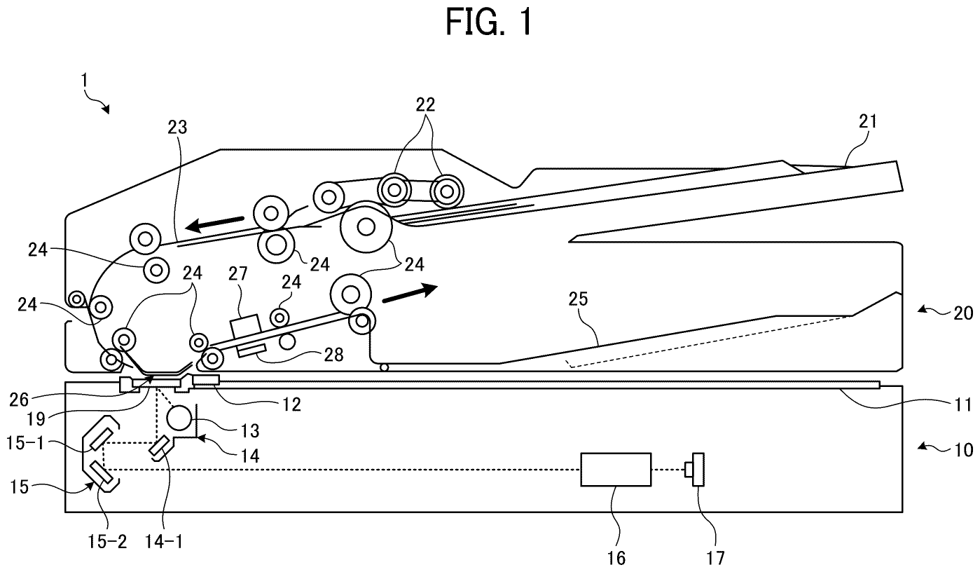

FIG. 1 is a diagram illustrating a configuration of a scanner 1 according to a first embodiment. A subject may be referred to as a read target in the following description. The read target includes a removal target such as a seal impression overlapping a black character area in which, for example, black characters are printed. Examples of the read target are paper documents such as various certificates, documents, or business forms on which a seal is stamped. However, the removal target is not limited to a seal impression. In addition, the read target is not limited to a paper document.

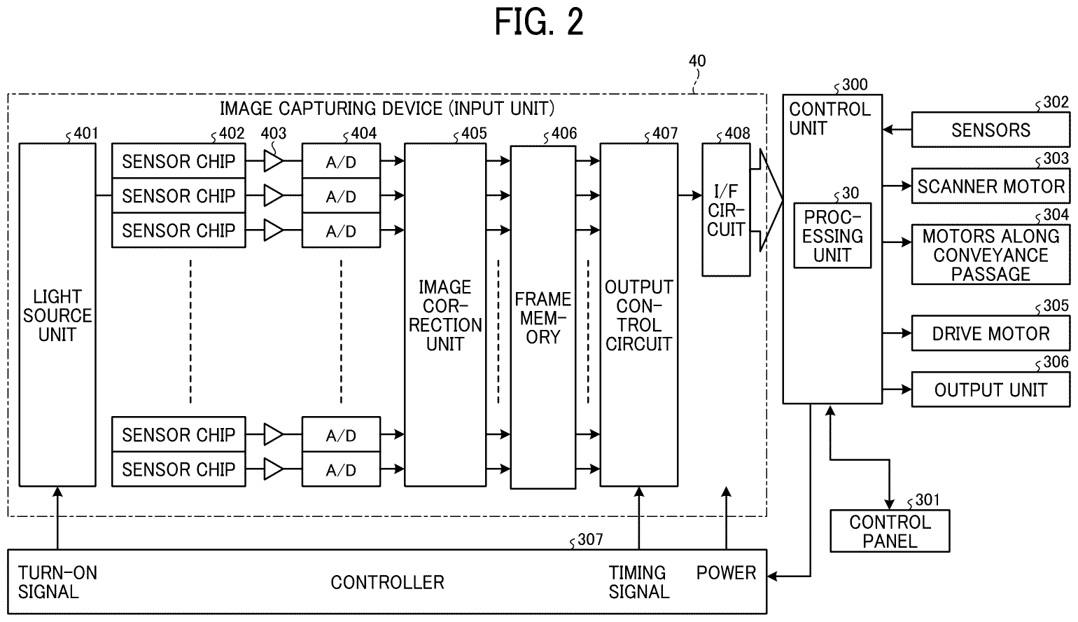

The scanner 1 as an image processing apparatus illustrated in FIG. 1 includes an exposure glass 11 on an upper side of a scanner body 10 and an image capturing device 40 as an imager (see FIG. 2) inside the scanner body 10. For example, a light source 13, a first carriage 14, a second carriage 15, a lens unit 16, and an image sensor 17 are disposed inside the scanner body 10. The first carriage 14 includes the light source 13 and a reflection mirror 14-1. The second carriage 15 includes reflection mirrors 15-1 and 15-2. The scanner body 10 also includes a control board. The control board is a control unit 300 illustrated in FIG. 2 and controls the entire operation of the scanner 1.

The control board causes the light source 13 to emit light while moving the first carriage 14 and the second carriage 15, and sequentially reads reflected light from a read target placed on the exposure glass 11 by the image sensor 17. When the light source 13 emits light, the light reflected by the read target is reflected by the reflection mirror 14-1 of the first carriage 14 and the reflection mirrors 15-1 and 15-2 of the second carriage 15 to enter the lens unit 16. The light emitted from the lens unit 16 forms an image on the image sensor 17. The image sensor 17 receives the reflected light from the read target and outputs an image signal. The image sensor 17 is an image sensor employing, for example, a charge coupled device (CCD) or a complementary metal oxide semiconductor (CMOS) and serves as a reading unit to read an image of the read target.

A reference white plate 12 is a reference used for white correction.

The scanner 1 illustrated in FIG. 1 is equipped with an automatic document feeder (ADF) 20. When one side of the ADF 20 is lifted, the ADF 20 is opened upward to expose the surface of the exposure glass 11. The user sets the read target on the exposure glass 11, lowers the ADF 20, and presses the ADF 20 against the exposure glass 11 from the second side (back side) of the read target. When a scan start key is pressed, the first carriage 14 and the second carriage 15 are driven to move in the main scanning direction and the sub-scanning direction so that the entire read target is read.

In addition to reading the read target set on the exposure glass 11, the scanner 1 can read the read target by a sheet-through method with the ADF 20. In the ADF 20, pickup rollers 22 separate a stack of read targets one by one from a tray 21 of the ADF 20. The scanner 1 reads one or both sides of the read target conveyed along a conveyance passage 23 and ejects the read target onto an output tray 25 while controlling various conveyance rollers 24.

The scanner 1 reads the read target through a reading window 19 in the sheet-through method with the ADF 20. In this example, the first carriage 14 and the second carriage 15 are moved to and kept at their respective home positions. When the read target passes between the reading window 19 and a background reference 26, the first side (front side) of the read target facing the reading window 19 is irradiated with light from the light source 13 so that an image is read. The reading window 19 is a slit-shaped window in a part of the exposure glass 11. The background reference 26 is a background member.

In the case of double-sided reading of the read target with the ADF 20, a reading module 27 as reading means reads the back side of the read target when facing the back side of the read target that has passed the reading window 19. The reading module 27 includes an irradiation unit, which includes a light source, and a contact image sensor serving as a second reading unit. The contact image sensor reads reflected light of light emitted to the second side of the read target. This light source may also include a visible light source and a near-infrared (NIR) light source to read a visible image and an NIR image. A background member 28 is a density reference member.

A description is given below of a configuration of a control block of the scanner 1.

FIG. 2 is a diagram illustrating a configuration of a control block of the scanner 1. As illustrated in FIG. 2, the scanner 1 includes the control unit 300, a control panel 301, various sensors 302, a scanner motor 303, various motors 304 disposed along the conveyance passage, a drive motor 305, an output unit 306, and the image capturing device 40. In addition, various objects to be controlled are connected. The sensors 302 detect the read target. The scanner motor 303 drives the first carriage 14 and the second carriage 15 of the scanner body 10. The motors 304 are disposed along the conveyance passage in the ADF 20. The output unit 306 corresponds to an output interface to output image data to an external device. The output interface may be a universal serial bus (USB) interface or a communication interface connected to a network.

The control panel 301 is, for example, a liquid crystal display (LCD) touch panel. The control panel 301 receives input operations such as various settings and reading execution (scan start) from a user through operation keys or touch input and transmits corresponding operation signals to the control unit 300. The control panel 301 displays, on the display screen, various kinds of display information from the control unit 300.

For example, the control panel 301 displays a software selection screen including a selection key for selecting the name of OCR software and instructs the control unit 300 to select the OCR software in response to an input operation with the selection key. The control panel 301 also displays a function setting screen including a selection key for selecting one or more functions of the OCR software selected on the software selection screen and instructs the control unit 300 to select the functions in response to an input operation with the selection key.

The image capturing device 40 includes a light source unit 401, sensor chips 402, amplifiers 403, analog-to-digital (A/D) converters 404, an image correction unit 405, a frame memory 406, an output control circuit 407, and an interface (I/F) circuit 408. Image data read from the read target is output, for each frame, from the output control circuit 407 to the control unit 300 through the I/F circuit 408. The sensor chips 402 are pixel sensors of the image sensor 17. The light source unit 401 is the light source 13.

The image capturing device 40 is driven by a controller 307. For example, the image capturing device 40 turns on the light source unit 401 based on a turn-on signal from the controller 307 to irradiate the read target with light at the set time. In addition, the image capturing device 40 converts the light that has been reflected from the read target and has formed an image on the sensor surface of the image sensor 17 into electrical signals with the sensor chips 402 and outputs the electrical signals.

The image capturing device 40 amplifies pixel signals output from the sensor chips 402 with the amplifiers 403, performs analog to digital conversion of the pixel signals with the A/D converters 404, and outputs level signals of the pixels. The image correction unit 405 performs image correction on the signal output from each pixel. For example, the image correction unit 405 performs shading correction on the signal output from each pixel.

After the image correction, each data is stored in the frame memory 406. The stored read image is transferred to the control unit 300 through the output control circuit 407 and the I/F circuit 408.

The control unit 300 includes a central processing unit (CPU) and a memory. The CPU controls the entire apparatus to perform a reading operation on a read target and the preprocessing for OCR on a read image obtained by the reading operation. The preprocessing for OCR precedes the OCR processing and is referred to as OCR preprocessing in the following description.

The control unit 300 includes a processing unit 30. The processing unit 30 can be implemented by the CPU executing a predetermined program. Alternatively, the processing unit 30 may be implemented by hardware such as an application-specific integrated circuit (ASIC).

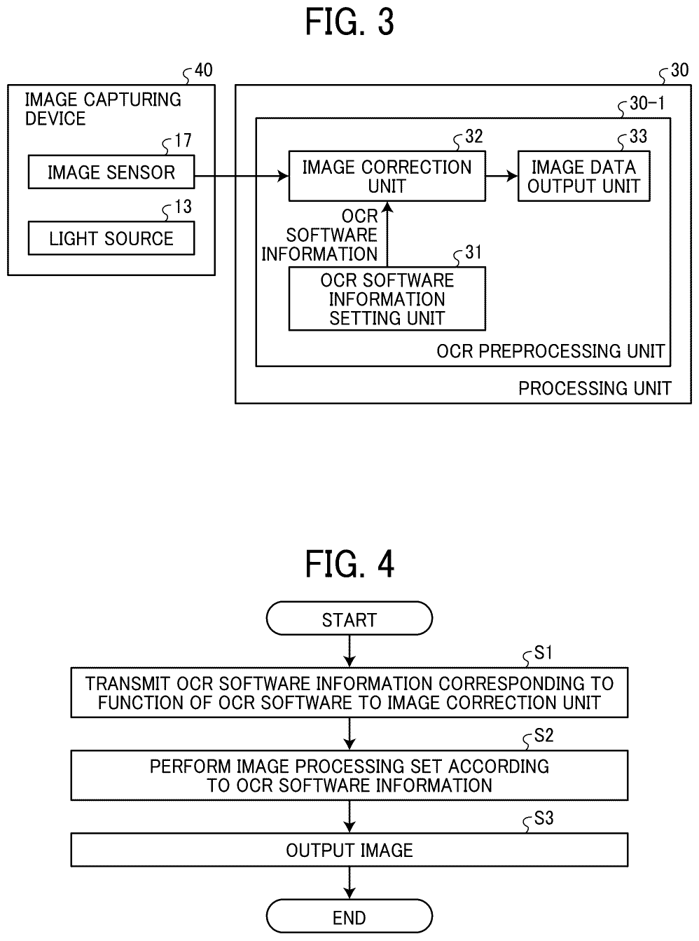

FIG. 3 is a schematic diagram illustrating a configuration for executing the OCR preprocessing. FIG. 4 is a flowchart of the OCR preprocessing. The image capturing device 40 includes the light source 13 and the image sensor 17 described above with reference to FIGS. 1 and 2. The image capturing device 40 irradiates a read target with light from the light source 13, receives reflected light from the read target with the image sensor 17, and outputs an image such as a red-green-blue (RGB) image.

As illustrated in FIG. 3, the processing unit 30 includes an OCR preprocessing unit 30-1. The OCR preprocessing unit 30-1 includes an OCR software information setting unit 31, an image correction unit 32, and an image data output unit 33.

The OCR software information setting unit 31 transmits OCR software information corresponding to the functions of the OCR software that is used for subsequent OCR processing to the image correction unit 32 (step S1 in FIG. 4). The OCR software that is used for subsequent OCR processing is not limited to the OCR software installed in the scanner 1 serving as an image processing apparatus. For example, the OCR software refers to all OCR software that use an image generated by the scanner 1 as the image processing apparatus, such as OCR software on a cloud or OCR software installed in a personal computer (PC).

The OCR software information setting unit 31 displays, for example, the software selection screen on the control panel 301.

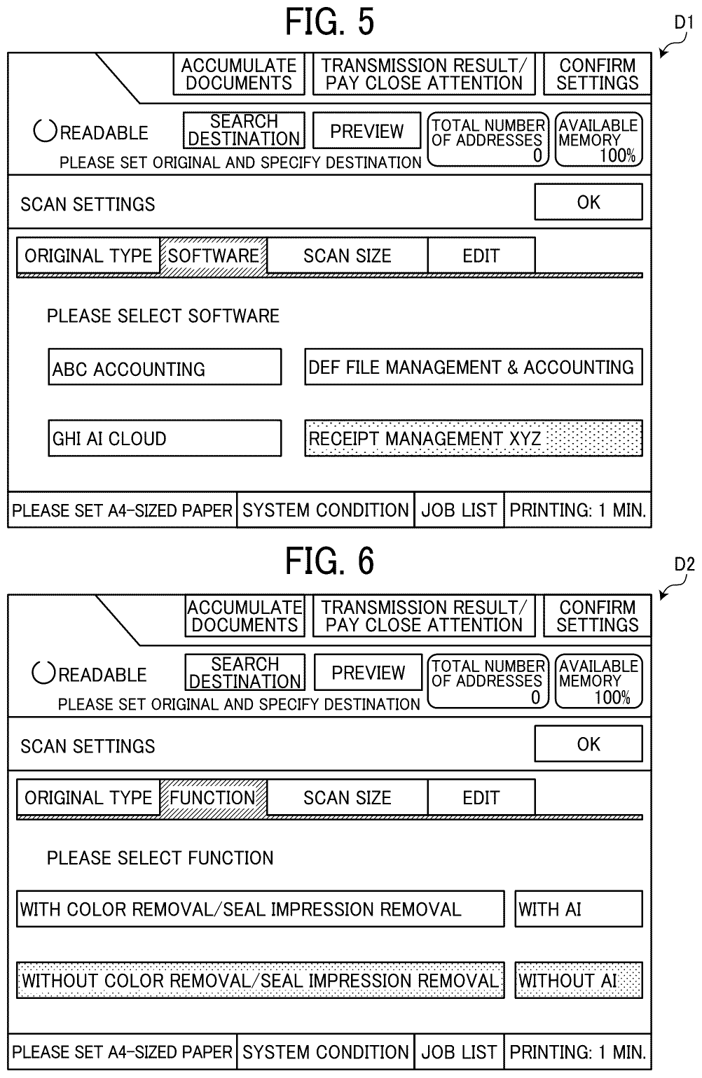

FIG. 5 is a diagram illustrating a software selection screen D1 as an example of the software selection screen on the control panel 301. As illustrated in FIG. 5, the OCR software information setting unit 31 displays the software selection screen D1 on the control panel 301. In the display example illustrated in FIG. 5, an OCR software name “receipt management xyz” is selected and the OK key is pressed. In response to the selection of the OCR software name on the software selection screen D1, the OCR software information setting unit 31 sets the OCR software information corresponding to the selected OCR software name. This obviates the need for the user's understanding of the processing of the OCR software and allows the image correction appropriate for the OCR software when the user simply selects the OCR software name.

The OCR software information setting unit 31 also displays, for example, the function selection screen on the control panel 301.

FIG. 6 is a diagram illustrating a function selection screen D2 as an example of the function selection screen on the control panel 301. As illustrated in FIG. 6, the OCR software information setting unit 31 displays the function selection screen D2 on the control panel 301. In the display example illustrated in FIG. 6, the functions of the OCR software “without color removal/seal impression removal” and “without AI” are selected and the OK key is pressed. In response to the selection of one or more functions of the OCR software on the function selection screen D2, the OCR software information setting unit 31 sets the OCR software information corresponding to the selected functions of the OCR software. This obviates the need for the user's understanding of the processing of the OCR software and allows the image correction appropriate for the OCR software when the user simply selects the functions of the OCR software.

The image correction unit 32 performs processing set according to the OCR software information transmitted from the OCR software information setting unit 31 on the image acquired by the image capturing device 40. Specifically, the image correction unit 32 performs the OCR preprocessing to increase the recognition rate of OCR processing or performs typical image processing to increase the image quality. The image correction unit 32 then transmits the image to the image data output unit 33 (step S2 in FIG. 4). Examples of the OCR preprocessing include the presence or absence of AI (with or without AI), the color removal/seal impression removal function, and image correction.

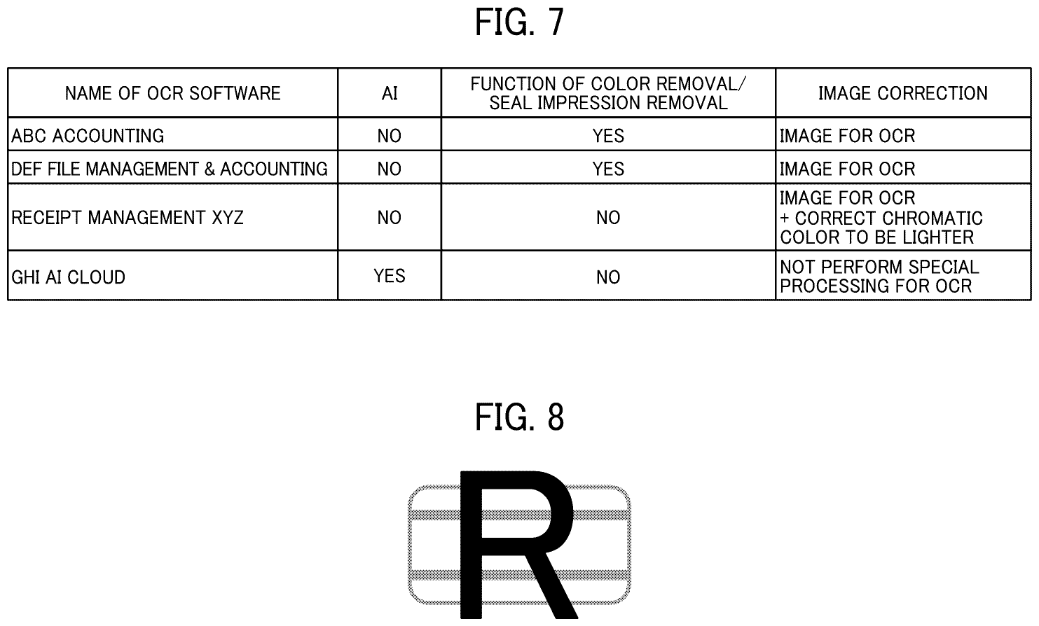

FIG. 7 is a table associating OCR software information, a color removal/seal impression removal function, and image correction with each other. As illustrated in FIG. 7, the image correction unit 32 stores the OCR software information, the presence or absence of AI, the color removal/seal impression removal function, and the description of image correction defining what kind of image correction is to be performed, in association with each other.

The OCR processing with AI is to perform inference using AI based on data learned so far (teacher data) and execute the OCR processing. The accuracy of OCR with AI can be maintained by correction to attain image quality close to that of the teacher data for the OCR software with AI for performing inference using AI based on the teacher data and executing the OCR processing.

As illustrated in FIG. 7, the image correction unit 32 has a function of turning off the OCR preprocessing. This is because untypical image processing may be executed when inference is performed using AI based on the data learned so far (teacher data) and the OCR processing is executed and, as a result, the image quality is different from that of the teacher data and the OCR processing may fail at the time of inference.

The image correction unit 32 can change the image correction by referring to the data stored as described above based on the OCR software information transmitted from the OCR software information setting unit 31.

The image data output unit 33 outputs the image transmitted from the image correction unit 32 by, for example, data transmission or display on the control panel 301 (step S3 in FIG. 4).

A description is given below of the OCR preprocessing executed by the image correction unit 32 to increase the recognition rate of the OCR processing on the image acquired by the image capturing device 40 based on the OCR software information transmitted from the OCR software information setting unit 31.

OCR processing techniques have been developed to automatically extract text information from a scanned image. Multiple types of OCR software implement such OCR processing. The multiple types of OCR software provide different methods of OCR processing from each other. The methods of OCR processing are provided by, for example, software with a seal impression removal and color removal function, software without the seal impression removal and the color removal function, and software with a recognition function using AI.

The image quality that facilitates successful OCR processing is different between these methods of OCR processing. For example, for the software with the seal impression removal and color removal function, image quality is required such that a character portion is accurately identified and the color removal/seal impression removal function is easily performed when color content is present around the character. For the software without the seal impression removal and color removal function, image quality is required such that the color content disappears in binarization (i.e., the color content is corrected to white by binarization) or such that a character is determined in pictorial pattern/character determination when color content is present around the character. The processing for generating such image quality that facilitates successful OCR processing is called OCR preprocessing. For the software with AI, image quality subjected to typical image processing and close to the image quality of the teacher data is required.

As described above, the image quality for easy character recognition varies depending on the OCR processing method of the OCR software. In the present embodiment, the accuracy of the OCR processing is enhanced by changing the OCR preprocessing of the image acquired by the image capturing device 40 according to the OCR software that is used for subsequent OCR processing.

A description is given below of an example of failure in the OCR processing.

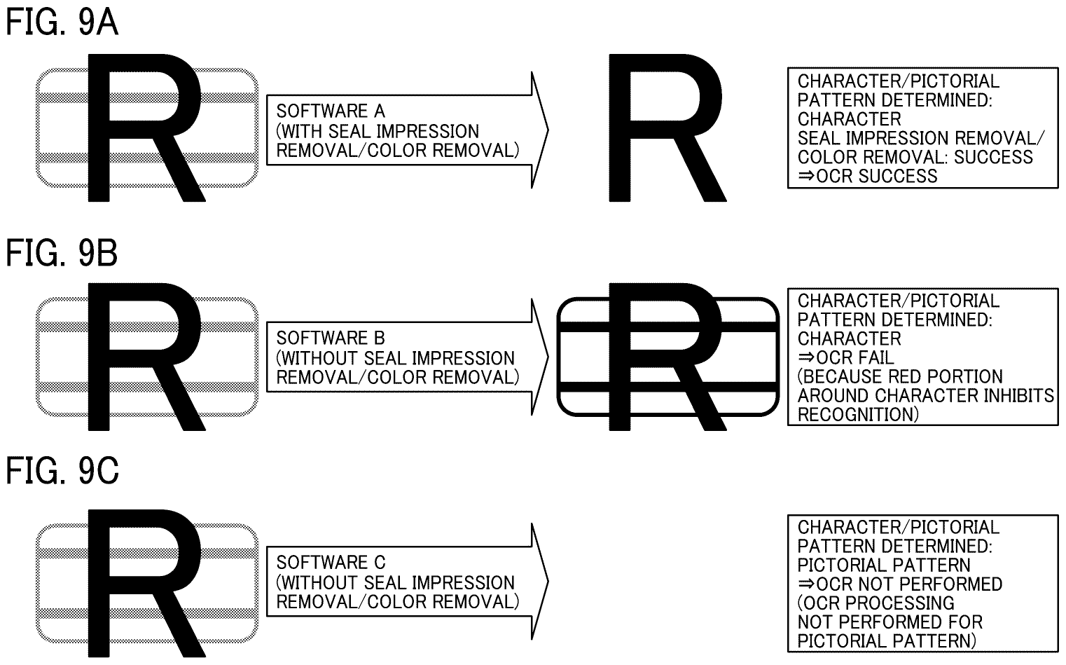

FIG. 8 is a diagram illustrating an image according to an example of failure in the OCR processing. FIGS. 9A to 9C are diagrams illustrating different results of OCR processing due to different processing methods of OCR software. A typical example of an image for which the OCR processing fails is an image in which a black character and color content (e.g., a seal, a ruled line, or a tint block) are mixed, as illustrated in FIG. 8.

Examples of the processing typically performed in the OCR preprocessing to increase the recognition rate of the OCR processing include color removal/seal impression removal, pictorial pattern/character area determination, binarization, and character recognition.

As illustrated in FIG. 9A, software A with the color removal/seal impression removal function can accurately determine the character area in the image illustrated in FIG. 8 in the pictorial pattern/character area determination and leave the black character portion by erasing color content (e.g., a seal, a ruled line, or a tint block) in the binarization. As a result, the OCR processing is successful and the character can be recognized.

By contrast, as illustrated in FIG. 9B, software B without the color removal/seal impression removal function can determine the character area in the image illustrated in FIG. 8 in the pictorial pattern/character area determination but fails to erase color content (e.g., a seal, a ruled line, or a tint block) in the binarization. The color content (e.g., a seal, a ruled line, or a tint block) around the black character inhibits character recognition, resulting in failure in the OCR processing and the character recognition.

As illustrated in FIG. 9C, software C without the color removal/seal impression removal function determines the image illustrated in FIG. 8 as the pictorial pattern in the pictorial pattern/character area determination because of the high density of the color content (e.g., a seal, a ruled line, or a tint block) and does not execute the OCR processing. As a result, the OCR processing and the character recognition fail.

As described above, when the density of color content (e.g., a seal, a ruled line, or a tint block) around a black character is high, the character may be determined as a pictorial pattern. A color content portion (e.g., a seal, a ruled line, or a tint block) may not be erased in the binarization. To address such situations, colors may be removed in the image correction before the OCR processing. However, this also causes the appearance of the image to be greatly different from that of the original image.

In the present embodiment, the image correction unit 32 changes the image processing (reduces the chromatic color while leaving the color information) of the image acquired by the image capturing device 40 according to the OCR software to prevent erroneous recognition during the pictorial pattern/character area determination and the binarization and enhance the accuracy of the OCR processing without significantly impairing the appearance of the original image. This point will be described in detail below.

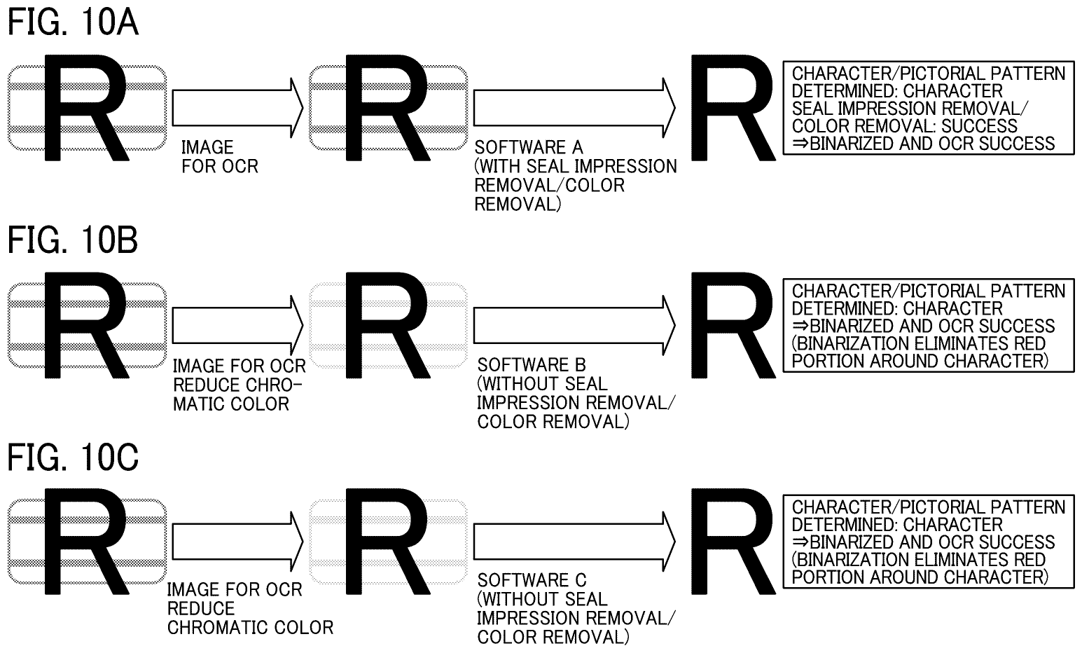

FIG. 10A is a diagram illustrating a result of OCR processing. FIGS. 10B and 10C are diagrams each illustrating a result of OCR processing when a chromatic color is corrected to be lighter in image correction.

As illustrated in FIG. 10A, the software A with the color removal/seal impression removal function can accurately determine, in the pictorial pattern/character area determination, the character area in the image illustrated in FIG. 8 with image quality for OCR processing and leave the black character portion by erasing color content (e.g., a seal, a ruled line, or a tint block) in the binarization. As a result, the OCR processing is successful and the character can be recognized.

As illustrated in FIG. 10B, the software B without the color removal/seal impression removal function can determine, in the pictorial pattern/character area determination, the character area in the image illustrated in FIG. 8 with image quality for OCR processing and the chromatic color corrected to be lighter and leave the black character portion by erasing color content (e.g., a seal, a ruled line, or a tint block) in the binarization. As a result, the OCR processing is successful and the character can be recognized.

As illustrated in FIG. 10C, the software C without the color removal/seal impression removal function can determine, in the pictorial pattern/character area determination, the character area in the image illustrated in FIG. 8 with image quality for OCR processing and the chromatic color corrected to be lighter and leave the black character portion by erasing color content (e.g., a seal, a ruled line, or a tint block) in the binarization. As a result, the OCR processing is successful and the character can be recognized.

As described above, the image correction unit 32 changes the image processing (e.g., reduces the chromatic color while leaving the color information) of the image acquired by the image capturing device 40 according to the OCR software to prevent erroneous recognition during the pictorial pattern/character area determination and the binarization and enhance the accuracy of the OCR processing without significantly impairing the appearance of the original image.

In other words, the image correction unit 32 changes the image processing (reduces the chromatic color while leaving the color information) of the image acquired by the image capturing device 40 according to the OCR software to prevent the OCR software without color removal or seal impression removal from being unable to recognize characters and enhance the accuracy of the OCR processing.

In the case of an accounting form, the chromatic color around characters is often red of a seal. Therefore, the image correction unit 32 may perform correction only for the red-based hue. In this case, colors other than red can be output in the same colors as in typical cases.

In other words, the image correction unit 32 changes the image processing (reduces red) of the image acquired by the image capturing device 40 according to the OCR software to prevent the OCR software without color removal or seal impression removal from being unable to recognize characters and enhance the accuracy of the OCR processing while outputting colors other than red in, for example, an accounting form with seals in the same manner as in typical cases.

As described above, according to the present embodiment, changing the image quality processing according to the OCR software that is used for subsequent OCR processing provides the image quality optimum for the OCR software and enhances the accuracy of the OCR processing.

In the present embodiment, the image correction unit 32 changes the image processing (reduces the chromatic color while leaving the color information) of the image acquired by the image capturing device 40 according to the OCR software. However, changing the image processing is not limited to reducing the chromatic color while leaving the color information.

Alternatively, the image correction unit 32 may change the image processing (changes the compression level) of the image acquired by the image capturing device 40 software according to the OCR software.

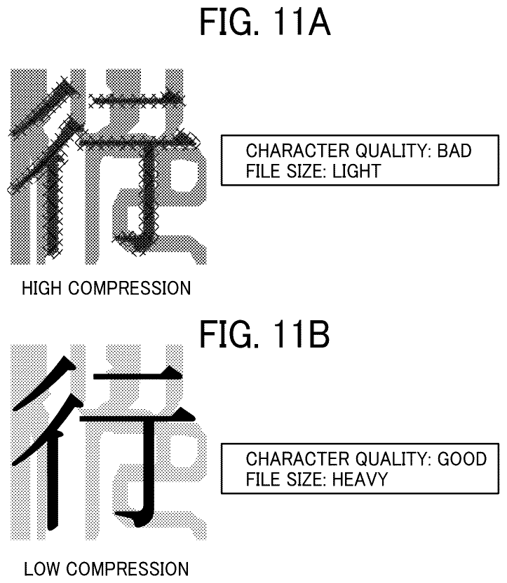

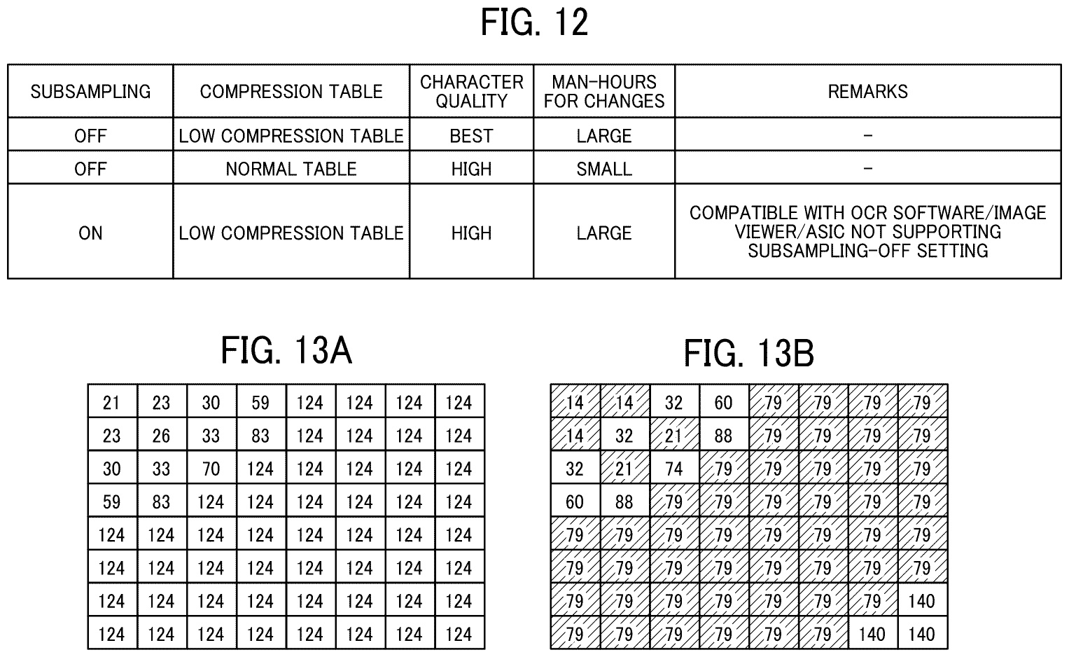

FIGS. 11A and 11B are diagrams illustrating differences in character quality and file size due to compression. FIG. 12 is a table illustrating methods of low-compression image correction. For example, some types of OCR software have a strict upper limit of the file size. For the OCR software having a strict upper limit of the file size, the risk of a size error is eliminated by the image correction with high compression.

By contrast, some other types of OCR software have a loose upper limit of the file size.

As illustrated in FIG. 11A, a high-compression image has poor character quality and a small file size (i.e., light). On the other hand, as illustrated in FIG. 11B, a low-compression image has good character quality and a large file size (i.e., heavy).

For example, for the OCR software having a loose upper limit of the file size, the image correction unit 32 executes low-compression image correction to provide an image with high character quality and enhance the accuracy of the OCR processing.

As illustrated in FIG. 12, for the OCR software having a loose upper limit of the file size, the image correction unit 32 turns off subsampling, which is the processing of thinning out data, and performs compression based on a low compression table to generate an image with the best character quality and enhance the accuracy of the OCR processing.

As illustrated in FIG. 12, for the OCR software having a loose upper limit of the file size, the image correction unit 32 turns off the subsampling as processing of thinning out data and performs compression based on a normal compression table to generate an image with high character quality and enhance the accuracy of the OCR processing. This case simply needs to change the subsampling setting and thus reduces the number of man-hours for changes.

Further, as illustrated in FIG. 12, for the OCR software having a loose upper limit of the file size, the image correction unit 32 turns on the subsampling as processing of thinning out data and performs compression based on a low compression table to generate an image with high character quality and enhance the accuracy of the OCR processing. In this case, the image correction unit 32 generates the image with high character quality and enhances the accuracy of the OCR processing while being compatible with OCR software and an image viewer that do not support subsampling off.

The low compression refers to that half or more of the elements of the low compression table have smaller values than the values of the corresponding elements of the normal compression table. FIG. 13A is an example of the normal compression table. FIG. 13B is an example of the low compression table. In the low compression table illustrated in FIG. 13B, smaller values than the values in the normal compression table illustrated in FIG. 13A are emphasized. As illustrated in FIG. 13B, half or more of the values (that is, 32 or more values) in the low compression table are smaller than the values in the normal compression table. Specifically, 53 values in the low compression table are smaller than the values in the normal compression table. The combination of the normal compression table illustrated in FIG. 13A and the low compression table illustrated in FIG. 13B is merely an example.

As described above, the image correction unit 32 changes the image processing (changes the compression level) of the image acquired by the image capturing device 40 according to the OCR software to generate an image according to the setting of the upper limit of the file size of the OCR software.

The OCR software information setting unit 31 may transmit the OCR software information corresponding to the OCR software to the image correction unit 32 in response to an instruction from the OCR software that is used for subsequent OCR processing. In this way, the time and effort of setting by the user can be reduced by changing the processing related to the image correction in response to an instruction from the OCR software that is used for subsequent OCR processing.

### Second Embodiment

A description is given below of a second embodiment.

The second embodiment is different from the first embodiment in that the image correction unit 32 changes the image processing (changes the resolution) of the image acquired by the image capturing device 40 according to the OCR software. Redundant descriptions of identical features in the first and second embodiments will be omitted in the following description. A description is given below of the features of the second embodiment different from the features of the first embodiment.

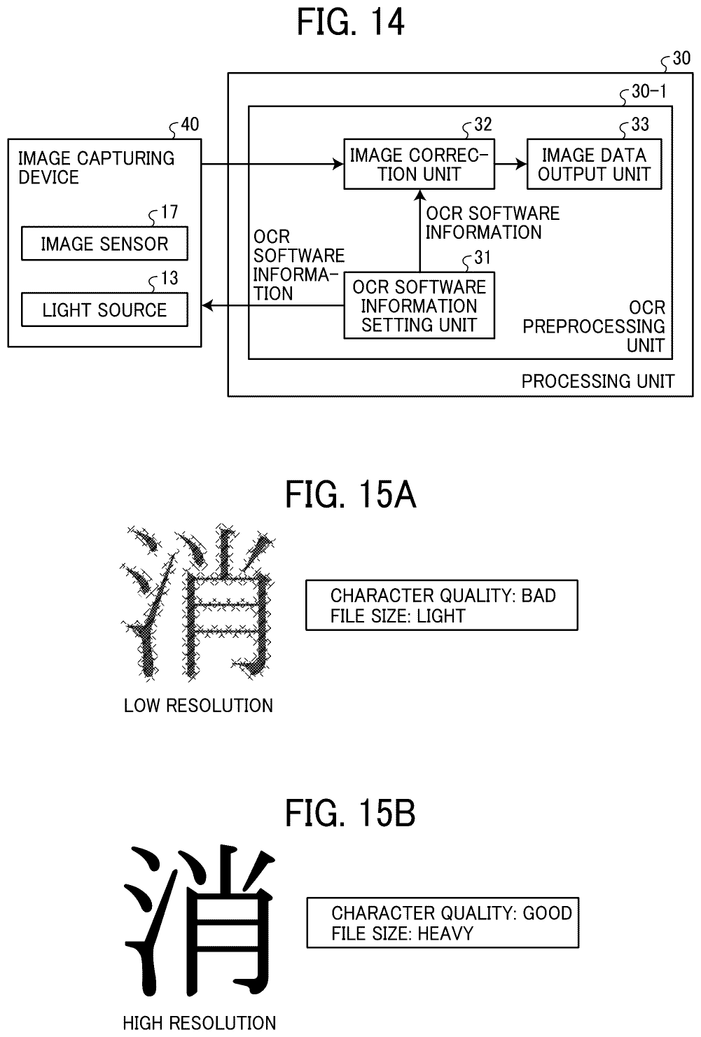

FIG. 14 is a schematic diagram illustrating a configuration for executing OCR preprocessing according to the second embodiment.

As illustrated in FIG. 14, the OCR software information setting unit 31 transmits OCR software information corresponding to the functions of the OCR software that is used for subsequent OCR processing to at least one of the image capturing device 40 and the image correction unit 32.

The image correction unit 32 performs OCR preprocessing to increase the recognition rate of OCR processing or performs normal image processing to increase the image quality on the image acquired by the image capturing device 40, based on the OCR software information transmitted from the OCR software information setting unit 31, and transmits the image to the image data output unit 33.

The image capturing device 40 changes the resolution based on the OCR software information transmitted from the OCR software information setting unit 31. The image capturing device 40 can change the resolution by, for example, changing the reading resolution of the image sensor or changing the conveyance speed of a read target.

FIGS. 15A and 15B are diagrams illustrating differences in character quality and file size due to resolution. For example, some types of OCR software have a strict upper limit of the file size. For the OCR software having a strict upper limit of the file size, the risk of a size error is eliminated by the image capturing with a low resolution and the image correction. By contrast, some other types of OCR software have a loose upper limit of the file size. For the OCR software having a loose upper limit of the file size, an image with high character quality can be provided and the accuracy of OCR processing can be enhanced by the image capturing with a high resolution and the image correction.

In recent years, compliance with the Law on Book and Record Keeping through Electronic Methods has been demanded in addition to the compatibility with OCR software.

The Law on Book and Record Keeping through Electronic Methods may require scan resolutions of 200 dots per inch (dpi) or higher. According to the present embodiment, an image can be captured with a high resolution of 200 dpi or higher while satisfying the requirements of the OCR software.

As described above, according to the present embodiment, at least one of the image capturing device 40 and the image correction unit 32 changes the image processing (changes the resolution) of the image acquired by the image capturing device 40 according to the OCR software to generate an image with a higher resolution.

In the present embodiment, the OCR software information setting unit 31 may transmit the OCR software information corresponding to the OCR software to at least one of the image capturing device 40 and the image correction unit 32 in response to an instruction from the OCR software that is used for subsequent OCR processing.

### Third Embodiment

A description is given below of a third embodiment.

The third embodiment is different from the first embodiment in that the image capturing device 40 includes a visible image capturing device 40-1 as a visible imager and an invisible image capturing device 40-2 as an invisible imager. Redundant descriptions of identical features in the first and third embodiments will be omitted in the following description. A description is given below of the features of the third embodiment different from the features of the first embodiment.

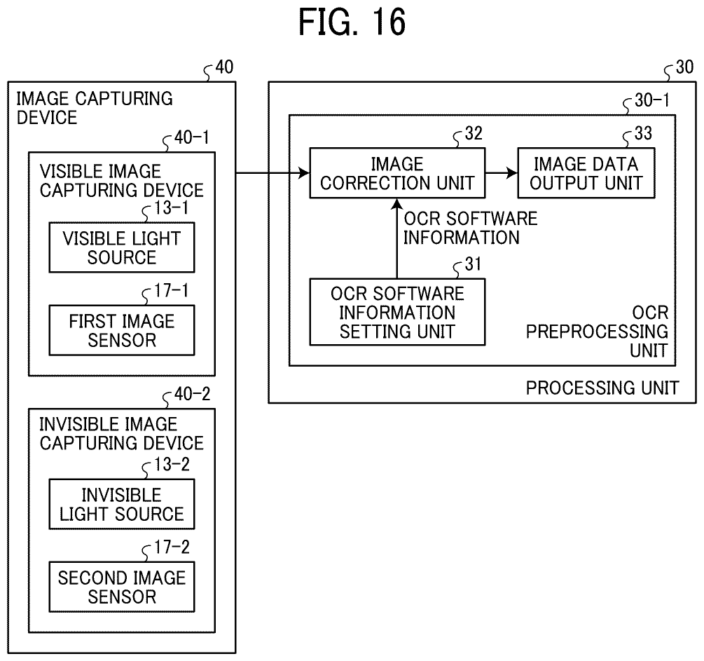

FIG. 16 is a schematic diagram illustrating a configuration for executing OCR preprocessing according to the third embodiment. As illustrated in FIG. 16, the image capturing device 40 includes the visible image capturing device 40-1 and the invisible image capturing device 40-2.

The light source 13 includes a visible light source 13-1 and an invisible light source 13-2. The image sensor 17 includes a first image sensor 17-1 and a second image sensor 17-2. The first image sensor 17-1 receives reflected light of visible light emitted to a read target and outputs an image. The second image sensor 17-2 receives reflected light of NIR light emitted to the read target and outputs an image. An image received when the read target is irradiated with visible light is referred to as a visible image, whereas an image received when the read target is irradiated with NIR light is referred to as an NIR image.

Although the visible light source 13-1 and the invisible light source 13-2 are separately provided as the light source 13, the visible light source 13-1 may be integral with the invisible light source 13-2 as a single light source.

The first image sensor 17-1 and the second image sensor 17-2 may be integral with each other as a single image sensor or separately provided as long as the first image sensor 17-1 and the second image sensor 17-2 can output the visible image and the NIR image, respectively.

The visible image capturing device 40-1 irradiates a read target with light from the visible light source 13-1, receives reflected light from the read target with the first image sensor 17-1, and outputs a visible image (e.g., an RGB image). The invisible image capturing device 40-2 irradiates the same read target with light from the invisible light source 13-2, receives reflected light from the read target with the second image sensor 17-2, and outputs an NIR image.

The image capturing device 40 can simultaneously read both a visible image and an NIR image from the same read target. When the read target is the same, the image capturing device 40 does not need to read both the visible image and the NIR image at the same time. The image capturing device 40 may read the visible image and the NIR image at different times as long as the positions of the respective image capturing targets match.

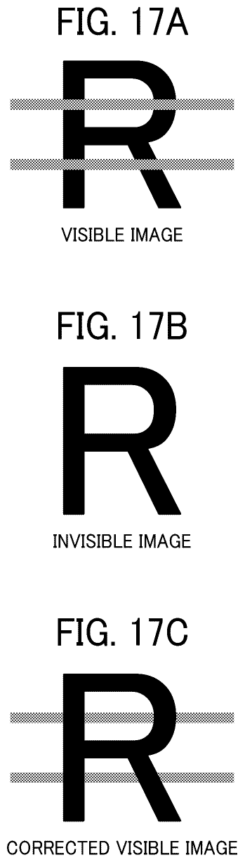

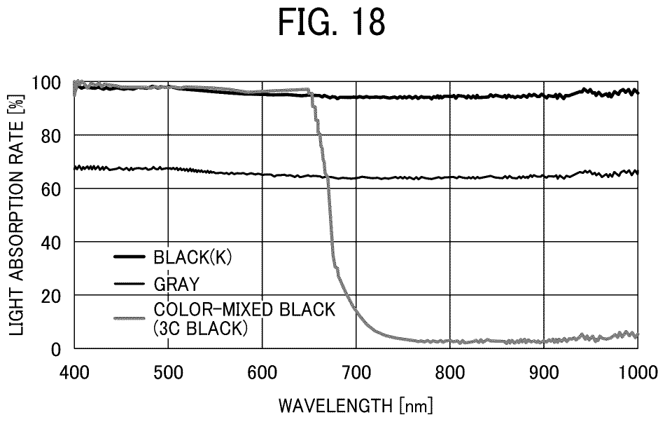

FIG. 17A is a diagram illustrating a visible image. FIG. 17B is a diagram illustrating an invisible image. FIG. 17C is a diagram illustrating the visible image of FIG. 17A corrected with the invisible image of FIG. 17B. In the example illustrated in FIGS. 17A to 17C, the image correction unit 32 corrects the visible image acquired by the visible image capturing device 40-1 with the invisible image based on the OCR software information transmitted from the OCR software information setting unit 31.

Black ink, black toner, or a black pencil used for black characters contains carbon. Carbon absorbs light in the visible area and the infrared area. Therefore, the black characters can be read in black in the visible area and the infrared area. On the other hand, color ink and cyan (C), magenta (M), and yellow (Y) color toners allow the transmission of light in the infrared area. This feature is illustrated in FIG. 18. The horizontal axis represents the wavelength of light, whereas the vertical axis represents the absorptance of light. In FIG. 18, “black (K)” refers to a color of a material containing carbon as described above, “gray” refers to a color printed with gray ink or black toner with thinning-out, and color-mixed black (3C black) refers to three-color mixed black, which is a black color produced by mixing C, M, and Y colors. Since the color-mixed black absorbs light in the visible area but allows the transmission of light in the near-infrared area, the color-mixed black can be read as white of white paper in the near-infrared area.

As illustrated in FIG. 17A, the image read in the visible area is an image (visible image) in which a black character and color content (e.g., a seal, a ruled line, or a tint block) are mixed. More specifically, as illustrated in FIG. 17A, the image read in the visible area is an image (visible image) in which color content (e.g., a seal, a ruled line, or a tint block) is superimposed on the black character.

On the other hand, as illustrated in FIG. 17B, the image read in the infrared area is an image (invisible image) of only a black character.

Then, as illustrated in FIG. 17C, the image correction unit 32 determines the position of the black character with the invisible image and performs correction to return the black character on which the color content is superimposed to the original black color. In this way, even when the color of the character is changed by, for example, a seal, the color of the character can be returned to the original color, and the seal impression removal/color removal of OCR software does not erase the character portion. Thus, the accuracy of OCR processing is enhanced.

As described above, according to the present embodiment, the accuracy of the OCR processing is enhanced by the image correction for returning, for example, a black character whose color has changed by color content (e.g., a seal, a ruled line, or a tint block) superimposing on the character to black using the result of the invisible image.

The image correction unit 32 reduces a chromatic color while leaving the color information or changes a compression level in the first embodiment, changes a resolution in the second embodiment, and performs correction with an invisible image in the third embodiment, according to the OCR software information of the OCR software. The image correction is not limited to these single image corrections, and a combination of the image corrections may be performed. Thus, an image optimal for OCR processing can be generated according to the OCR software.

### Fourth Embodiment

A description is given below of a fourth embodiment.

The fourth embodiment is different from the third embodiment in that the image correction unit 32 changes the operation of the image capturing device 40 (the visible image capturing device 40-1 and the invisible image capturing device 40-2) according to the OCR software that is used for subsequent OCR processing. Redundant descriptions of identical features in the third and fourth embodiments will be omitted in the following description. A description is given below of the features of the fourth embodiment different from the features of the third embodiment.

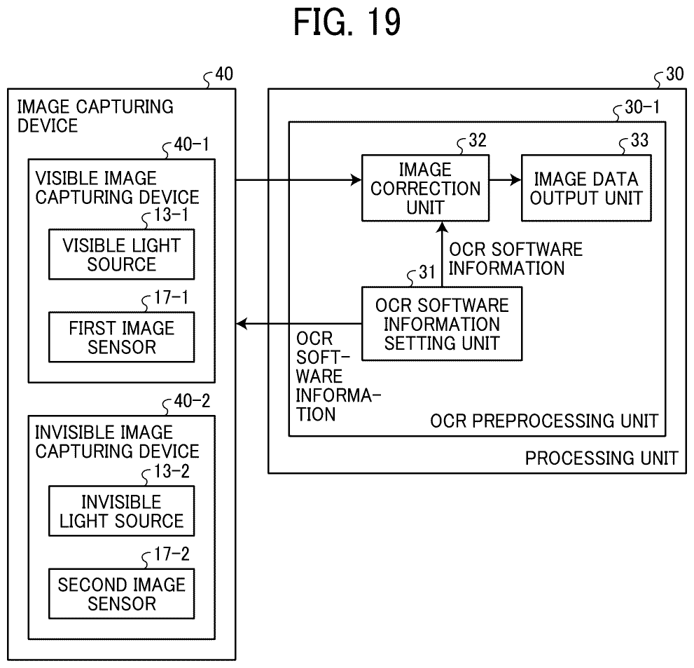

FIG. 19 is a schematic diagram illustrating a configuration for executing OCR preprocessing according to the fourth embodiment.

As illustrated in FIG. 19, the OCR software information setting unit 31 transmits OCR software information corresponding to the functions of the OCR software that is used for subsequent OCR processing to at least one of the image capturing device 40 and the image correction unit 32.

The image correction unit 32 performs OCR preprocessing to increase the recognition rate of OCR processing or performs normal image processing to increase the image quality on the image acquired by the image capturing device 40, based on the OCR software information transmitted from the OCR software information setting unit 31, and transmits the image to the image data output unit 33.

The image acquired by the image capturing device 40 is an example. The image corrected by the image correction unit 32 may not be the captured image. For example, image correction may be performed on an image stored in an internal storage or an image transmitted through a network.

The image capturing device 40 may change the operation according to the OCR software information transmitted from the OCR software information setting unit 31. A description is given below of several cases in the present embodiment.

Case where Visible Image Capturing Device 40-1 and Invisible Image Capturing Device 40-2 are Operated

For example, when specific OCR software is used, the image capturing device 40 operates the visible image capturing device 40-1 and the invisible image capturing device 40-2. By the correction with the invisible image for the OCR software whose accuracy is increased by image correction with the invisible image, the accuracy of the OCR processing is enhanced.

Case where Only Visible Image Capturing Device 40-1 is Operated

For example, when specific OCR software is used, the image capturing device 40 operates only the visible image capturing device 40-1. Since unnecessary invisible components can be removed in capturing a visible image, the color mixture of the invisible components to the visible image can be prevented and the image quality of the visible image can be enhanced, compared to the case where the visible image capturing device 40-1 and the invisible image capturing device 40-2 are operated.

Case where Only Invisible Image Capturing Device 40-2 is Operated

For example, when specific OCR software is used, the image capturing device 40 operates only the invisible image capturing device 40-2. Although the appearance changes due to the invisible image capturing, the accuracy of the OCR processing can be enhanced without executing special image processing.

As described above, according to the present embodiment, an image appropriate for the OCR software can be captured by operating either or both of the visible image capturing device 40-1 and the invisible image capturing device 40-2 based on the OCR software information from the OCR software information setting unit 31.

### Fifth Embodiment

A description is given below of a fifth embodiment.

The fifth embodiment is different from the first embodiment in that the image correction unit 32 includes a common correction unit 32-1 and an OCR software information changing correction unit 32-2.

Redundant descriptions of identical features in the first and fifth embodiments will be omitted in the following description. A description is given below of the features of the fifth embodiment different from the features of the first embodiment.

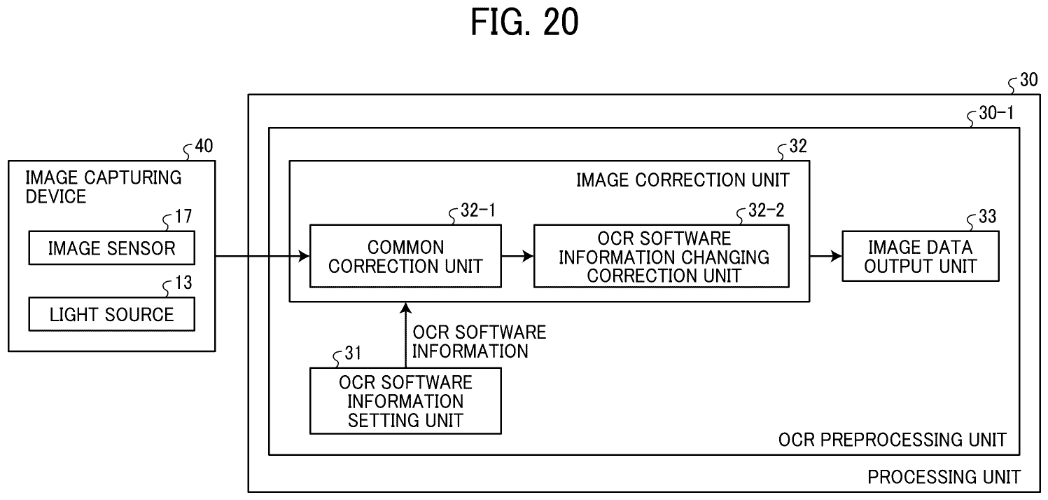

FIG. 20 is a schematic diagram illustrating a configuration for executing OCR preprocessing according to the fifth embodiment. As illustrated in FIG. 20, the image correction unit 32 includes the common correction unit 32-1 and the OCR software information changing correction unit 32-2.

The common correction unit 32-1 performs correction common to multiple types of OCR software, such as noise removal and background removal.

The OCR software information changing correction unit 32-2 executes correction appropriate for specific OCR software, such as scaling, compression, and correction based on invisible information.

As described above, according to the present embodiment, the functions generated by the common correction unit 32-1 are made common to reduce the number of design steps/maintenance steps.

### Sixth Embodiment

A description is given below of a sixth embodiment.

The sixth embodiment is different from the first embodiment in that the OCR software information is set according to the determination of AI. Redundant descriptions of identical features in the first and sixth embodiments will be omitted in the following description. A description is given below of the features of the sixth embodiment different from the features of the first embodiment.

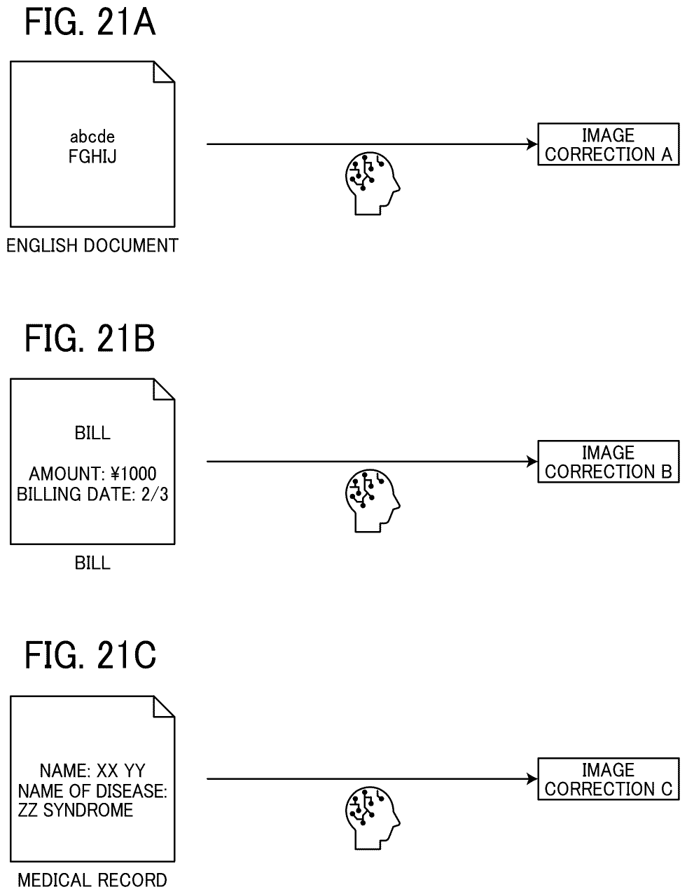

FIGS. 21A to 21C are diagrams each illustrating automatic association of image correction by AI according to the sixth embodiment. As illustrated in FIGS. 21A to 21C, the OCR software information setting unit 31 sets the OCR software information according to the determination of AI that has learned teacher data in which a document (e.g., an English document in FIG. 21A, a bill in FIG. 21B, or a medical record in FIG. 21C) to be read is associated with the success rate of the OCR processing. The image correction unit 32 automatically determines image correction optimal for the document to be read according to the OCR software information.

As described above, according to the present embodiment, the time and effort of the user for setting is eliminated.

### Seventh Embodiment

The scanner according to the first embodiment may be mounted on an image forming apparatus.

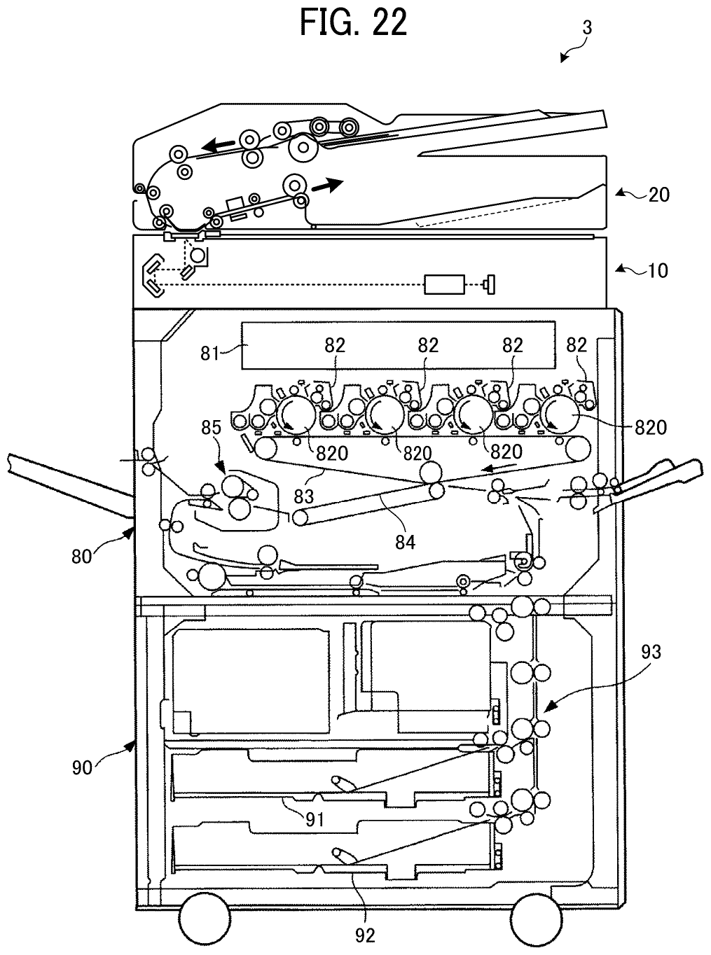

FIG. 22 is a schematic diagram illustrating a configuration of an image forming apparatus according to a seventh embodiment. FIG. 22 illustrates an image forming apparatus 3 that is typically called a multifunction peripheral (MFP) as an example. The image forming apparatus 3 illustrated in FIG. 22 includes a scanner (the scanner body 10 and the ADF 20) in an upper portion thereof. Since the configuration of the scanner is described above in the first embodiment, a detailed description thereof is herein omitted.

The image forming apparatus 3 illustrated in FIG. 22 includes an image forming device 80 and a sheet feeder 90 below the scanner body 10.

The image forming device 80 prints an image read in the scanner body 10 on a recording sheet, which is an example of a recording medium. The read image is a visible image or an NIR image.

The image forming device 80 includes an optical writing device 81, tandem image forming units 82 for yellow (Y), magenta (M), cyan (C), and black (K), an intermediate transfer belt 83, and a secondary transfer belt 84. In the image forming device 80, the optical writing device 81 writes an image to be printed on a drum-shaped photoconductor 820 of each of the image forming units 82, and respective color toner images are transferred from the photoconductors 820 onto the intermediate transfer belt 83. The toner image of K plate is formed with K toner containing carbon black.

The four image forming units 82 for Y, M, C, and K include the rotatable drum-shaped photoconductors 820 for Y, M, C, and K, respectively. Each of the four photoconductors 820 is surrounded by various pieces of image forming equipment such as a charging roller, a developing device, a primary transfer roller, a cleaner unit, and a neutralizer. Such pieces of image forming equipment operate around each of the photoconductors 820 in a series of image forming processes to form an image on the photoconductor 820. The image thus formed on each of the photoconductors 820 is transferred, by the primary transfer roller, as a toner image onto the intermediate transfer belt 83.

The intermediate transfer belt 83 is entrained around a drive roller and a driven roller so as to pass through primary transfer nips between the four photoconductors 820 and the respective primary transfer rollers. As the intermediate transfer belt 83 rotates, the toner images primarily transferred onto the intermediate transfer belt 83 are conveyed to a secondary transfer device, which secondarily transfers the toner images as a composite toner image onto a recording sheet on the secondary transfer belt 84. As the secondary transfer belt 84 travels, the recording sheet is conveyed to a fixing device 85, which fixes the composite toner image as a color image onto the recording sheet. Finally, the recording sheet is ejected onto an output tray outside the housing of the image forming device 80.

The recording sheet is fed from, for example, one of input trays 91 and 92 of the sheet feeder 90. The input trays 91 and 92 store different sizes of recording media. The recording sheet thus fed is conveyed through a conveyance unit 93 that includes rollers to the secondary transfer belt 84.

The image forming device 80 is not limited to an electrophotographic image forming device that forms an image by electrophotography as described above. Alternatively, the image forming device 80 may be an inkjet image forming device that forms an image in an inkjet system. The image forming apparatus 3 is not limited to an MFP having at least two of copying, printing, scanning, and facsimile functions. Alternatively, the image forming apparatus 3 may be, for example, a copier, a scanner, or a facsimile machine. The image forming apparatus 3 may be, for example, a printer that receives image data generated by a separate image processing apparatus through, for example, a communication network and prints an image based on the received image data.

A description is given below of several aspects of the present disclosure.

According to a first aspect, an image processing apparatus includes an image capturing device as an imager, an OCR software information setting unit, an image correction unit, and an image data output unit. The image capturing device captures an image. The OCR software information setting unit sets OCR software information corresponding to OCR software that is used for subsequent OCR processing. The image correction unit performs image correction set according to the OCR software information set by the OCR software information setting unit on the image captured by the image capturing device. The image data output unit outputs the image corrected by the image correction unit.

According to a second aspect, in the image processing apparatus of the first aspect, the image correction unit corrects a chromatic color to be lighter when the set OCR software information indicates OCR software without color removal or seal impression removal.

According to a third aspect, in the image processing apparatus of the first or second aspect, the image correction unit corrects red to be lighter when the set OCR software information indicates OCR software without color removal or seal impression removal.

According to a fourth aspect, in the image processing apparatus of any one of the first to third aspects, the image correction unit changes a compression level of the image according to a setting of an upper limit of a file size of the OCR software corresponding to the set OCR software information.

According to a fifth aspect, in the image processing apparatus of the fourth aspect, the image correction unit turns off subsampling as processing of thinning out data and performs compression based on a low compression table.

According to a sixth aspect, in the image processing apparatus of the fourth aspect, the image correction unit turns off subsampling as processing of thinning out data and performs compression based on a normal compression table.

According to a seventh aspect, in the image processing apparatus of the fourth aspect, the image correction unit turns on subsampling as processing of thinning out data and performs compression based on a low compression table.

According to an eighth aspect, in the image processing apparatus of any one of the first to seventh aspects, the image correction unit or the image capturing unit changes a resolution of the image or image correction according to an upper limit of a file size of the OCR software corresponding to the set OCR software information.

According to a ninth aspect, in the image processing apparatus of the eighth aspect, the image capturing device changes a resolution according to the OCR software information set by the OCR software information setting unit to capture the image.

According to a tenth aspect, in the image processing apparatus of the eighth aspect, the image correction unit changes a resolution according to the OCR software information set by the OCR software information setting unit.

According to an eleventh aspect, in the image processing apparatus of the first aspect, the image capturing device includes a visible image capturing device to capture a visible image and an invisible image capturing device to capture an invisible image, and the image correction unit corrects the visible image captured by the visible image capturing device with the invisible image.

According to a twelfth aspect, in the image processing apparatus of the first aspect, the image capturing device includes a visible image capturing device to capture a visible image and an invisible image capturing device to capture an invisible image, and at least one of the visible image capturing device and the invisible image capturing device changes an operation according to the OCR software information set by the OCR software information setting unit.

According to a thirteenth aspect, in the image processing apparatus of any one of the first to twelfth aspects, the image correction unit includes a common correction unit to execute correction common to multiple types of OCR software and an OCR software information changing correction unit to execute correction appropriate for specific OCR software.

According to a fourteenth aspect, in the image processing apparatus of any one of the first to thirteenth aspects, the image correction unit turns off the image correction when the set OCR software information indicates OCR software with AI.

According to a fifteenth aspect, in the image processing apparatus of any one of the first to fourteenth aspects, the image correction unit refers to data in which OCR software information, the presence or absence of AI, a color removal/seal impression removal function, and a description of image correction defining what kind of image correction is to be performed are registered, to perform the image correction set according to the OCR software information set by the OCR software information setting unit.

According to a sixteenth aspect, in the image processing apparatus of any one of the first to fifteenth aspects, the OCR software information setting unit sets the OCR software information according to a selected OCR software name.

According to a seventeenth aspect, in the image processing apparatus of any one of the first to sixteenth aspects, the OCR software information setting unit sets the OCR software information according to a selected function of the OCR software.

According to an eighteenth aspect, in the image processing apparatus of any one of the first to seventeenth aspects, the OCR software information setting unit sets the OCR software information according to the determination of AI.

According to a nineteenth aspect, in the image processing apparatus of any one of the first to eighteenth aspects, the OCR software information setting unit sets the OCR software information in response to an instruction from the OCR software that is used for the subsequent OCR processing.

According to a twentieth aspect, an image forming apparatus includes the image processing apparatus of any one of the first to nineteenth aspects and an image forming device to form an image based on image data generated by the image processing apparatus.

According to a twenty-first aspect, a program for causing a computer, which controls an image processing apparatus including an image capturing device as an imager to capture an image, to serve as an OCR software information setting unit, an image correction unit, and an image data output unit. The OCR software information setting unit sets OCR software information corresponding to OCR software that is used for subsequent OCR processing. The image correction unit performs image correction set according to the OCR software information set by the OCR software information setting unit on the image captured by the image capturing device. The image data output unit outputs the image corrected by the image correction unit.

According to a twenty-second aspect, an image correction method, which is executed by an image processing apparatus including an image capturing device as an imager to capture an image, includes an OCR software information setting step, an image correction step, and an image output step. The OCR software information setting step is a step of setting OCR software information corresponding to OCR software that is used for subsequent OCR processing. The image correction step is a step of performing image correction set according to the OCR software information set by the OCR software information setting step on the image captured by the image capturing device. The image output step is a step of outputting the image corrected by the image correction step.

According to one or more aspects of the present disclosure, image correction can be performed on an input image as appropriate for multiple types of OCR software to enhance the accuracy of OCR processing.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc read-only memory (CD-ROM) or digital versatile disk (DVD), and/or the memory of an FPGA or ASIC.

1. An image processing apparatus comprising:
an imager to capture an image; and
circuitry configured to:
set Optical Character Recognition (OCR) software information corresponding to OCR software used for subsequent OCR processing;
perform image correction set according to the set OCR software information on the image captured by the imager to obtain a corrected image; and
output the corrected image.

2. The image processing apparatus according to claim 1,
wherein the circuitry is configured to correct a chromatic color to be lighter when the set OCR software information indicates OCR software without color removal or seal impression removal.

3. The image processing apparatus according to claim 1,
wherein the circuitry is configured to correct red to be lighter when the set OCR software information indicates OCR software without color removal or seal impression removal.

4. The image processing apparatus according to claim 1,
wherein the circuitry is configured to change a compression level of the image according to a setting of an upper limit of a file size of the OCR software corresponding to the set OCR software information.

5. The image processing apparatus according to claim 4,
wherein the circuitry is configured to turn off subsampling as processing of thinning out data and perform compression based on a low compression table.

6. The image processing apparatus according to claim 4,
wherein the circuitry is configured to turn off subsampling as processing of thinning out data and perform compression based on a normal compression table.

7. The image processing apparatus according to claim 4,
wherein the circuitry is configured to turn on subsampling as processing of thinning out data and perform compression based on a low compression table.

8. The image processing apparatus according to claim 1,
wherein at least one of the circuitry or the imager is configured to change a resolution of the image or image processing for the image correction according to an upper limit of a file size of the OCR software corresponding to the set OCR software information.

9. The image processing apparatus according to claim 1,
wherein the imager includes:
a visible imager to capture a visible image; and
an invisible imager to capture an invisible image, and
wherein the circuitry is configured to correct the visible image captured by the visible imager with the invisible image to obtain the corrected image.

10. The image processing apparatus according to claim 1,
wherein the imager includes:
a visible imager to capture a visible image; and
an invisible imager to capture an invisible image, and
wherein at least one of the visible imager or the invisible imager changes an operation according to the OCR software information set by the circuitry.

11. The image processing apparatus according to claim 1,
wherein the circuitry is configured to:
execute correction common to multiple types of OCR software; and
execute correction appropriate for specific OCR software.

12. The image processing apparatus according to claim 1,
wherein the circuitry is configured to turn off the image correction when the set OCR software information indicates OCR software with artificial intelligence (AI).

13. The image processing apparatus according to claim 1,
wherein the circuitry is configured to refer to data in which OCR software information, presence or absence of AI, a color removal/seal impression removal function, and a description of image correction defining what kind of image correction is to be performed are registered, to perform the image correction set according to the set OCR software information.

14. The image processing apparatus according to claim 1,
wherein the circuitry is configured to set the OCR software information according to a selected OCR software name.

15. The image processing apparatus according to claim 1,
wherein the circuitry is configured to set the OCR software information according to a selected function of the OCR software.

16. The image processing apparatus according to claim 1,
wherein the circuitry is configured to set the OCR software information according to a determination of AI.

17. The image processing apparatus according to claim 1,
wherein the circuitry is configured to set the OCR software information in response to an instruction from the OCR software used for the subsequent OCR processing.

18. An image forming apparatus, comprising:
the image processing apparatus according to claim 1; and
an image forming device to form an image based on image data generated by the image processing apparatus.

19. A non-transitory recording medium storing a plurality of instructions which, when executed by one or more processors, causes the one or more processors to perform an image correction method, the method comprising:
setting OCR software information corresponding to OCR software used for subsequent OCR processing;
performing image correction set according to the set OCR software information on an image captured by an imager to obtain a corrected image; and
outputting the corrected image.

20. An image correction method, comprising:
setting OCR software information corresponding to OCR software used for subsequent OCR processing;
performing image correction set according to the set OCR software information on an image captured by an imager to obtain a corrected image; and
outputting the corrected image.
